(19) United States
(12) Patent Application Publication
(10) Pub. No.: US 2008/0106365 A1
(43) Pub. Date: May 8, 2008

(54) Analog Line-Type Fixed Temperature Fire Detection Cable

(76) Inventors: Gangjin Li, Beijing (CN); Weishe Zhang, Beijing (CN)

Correspondence Address: LADAS & PARRY LLP, 224 SOUTH MICHIGAN AVENUE, SUITE 1600, CHICAGO, IL, 60604, US

(21) Appl. No.: 11/814,823

(22) PCT Filed: Apr. 29, 2006
(86) PCT No.: PCT/CN06/00860

§ 371 Date: Dec. 3, 2007

(30) Foreign Application Priority Data
Nov. 14, 2005 (CN) 200510114820.4

(51) Int. Cl. G08B 17/06; H01H 37/76; G01K 7/00

(52) U.S. Cl. 337/401; 374/163; 374/E07.001

(57) ABSTRACT

An analog line-type fixed temperature fire detection cable that has two detection conductors positioned in parallel, an isolation layer of NTC character, and a fusible insulation layer having a fusion temperature of 20° C.˜140° C., with the isolation layer of NTC characteristics and the fusible insulation layer positioned between the two parallel detection conductors. The cable has the advantage of improved reliability and usable length of the analog line-type fixed temperature detection cable.

### TECHNICAL FIELD

The present invention relates to an analog line-type fixed temperature fire detection cable, in which a fusible insulation layer is added between two detection conductors. Therefore, the problem of false alarm of an analog line-type fixed temperature fire detection cable resulted from the length of the detector and the environment temperature has been solved.

### DESCRIPTION OF THE RELATED ART

Conventional analog line-type fixed temperature fire detection cable of NTC characteristic is a kind of widely used fire detection cable of the prior art, wherein FIG. 1 shows a structural schematic view (cross sectional view of the cable) of a conventional analog line-type fixed temperature fire detection cable, in which two detection conductors 1 and 2 are positioned in parallel with an isolation layer 3 of NTC characteristics (NTC character refers to negative temperature coefficient character) therebetween. When the detection cable is heated, the resistance of the NTC isolation layer 3 between the two detection conductors will reduce as the temperature of the cable increases. On this basis, fire alarm may be performed through detection of the temperature. The sensing cable disclosed in Chinese Patent No. ZL 03242897.9 is one of the aforesaid cables. The alarm temperature of the detection cable of the prior art is influenced by four factors, namely the heated length, heating temperature, environment temperature and the entire length of the detection cable; while it is desired that the alarm temperature of the detection cable is relevant only to two factors, namely the heated length and heating temperature of the detection cable in a fire, and is not relevant or less relevant to other factors. The other two factors cannot be eliminated in the NTC analog line-type fixed temperature detection cable of the prior art. Therefore the detection cable may have a poor reliability and may produce a false alarm under high temperature, and thus is unsuitable for outdoor work. Accordingly, there is a need for a new style analog line-type fixed temperature detection cable.

### SUMMARY OF THE INVENTION

The object of the present invention is to provide an analog line-type fixed temperature detection cable with a fusible insulation layer having a fusion temperature of 20□˜140□ positioned between two detection conductors, thereby increasing reliability and usable length of the analog line-type fixed temperature detection cable.

The object of the present invention is achieved by the following technical solution, that is, an analog line-type fixed temperature detection cable characterized by comprising two detection conductors positioned in parallel, an isolation layer of NTC characteristic, a fusible insulation layer having a fusion temperature of 20□˜140□, wherein the isolation layer of NTC characteristics and the fusible insulation layer are interposed between the two parallel detection conductors.

The present invention has the following advantage over the prior art:

1. The influence of the usable length of the detector and the temperature of environment where the detection cable is located on the alarm temperature of the detector is eliminated by using a fusible insulation layer having a fusion temperature of 20□˜140□ in the fixed temperature fire detection cable of the present invention.

2. The present invention has overcome false alarm resulted from the length of the detection cable and the environment temperature in the conventional analog line-type fixed temperature detector.

### BRIEF DESCRIPTION OF THE DRAWINGS

The present invention will be further described hereafter with reference to the accompanying drawings and the preferred embodiments.

FIG. 1 shows a structural schematic view of a conventional analog line-type fixed temperature fire detection cable;

FIG. 2 shows a structural schematic view of the present invention;

FIG. 3 shows the first structure of the present invention;

FIG. 4 shows the second structure of the present invention;

FIG. 5 shows the third structure of the present invention;

FIG. 6 shows a schematic structural view of the second embodiment of the present invention;

FIG. 7 shows a schematic view of the line-type fixed temperature detector of the present invention;

FIG. 8 shows a schematic structural view of the third embodiment of the present invention.

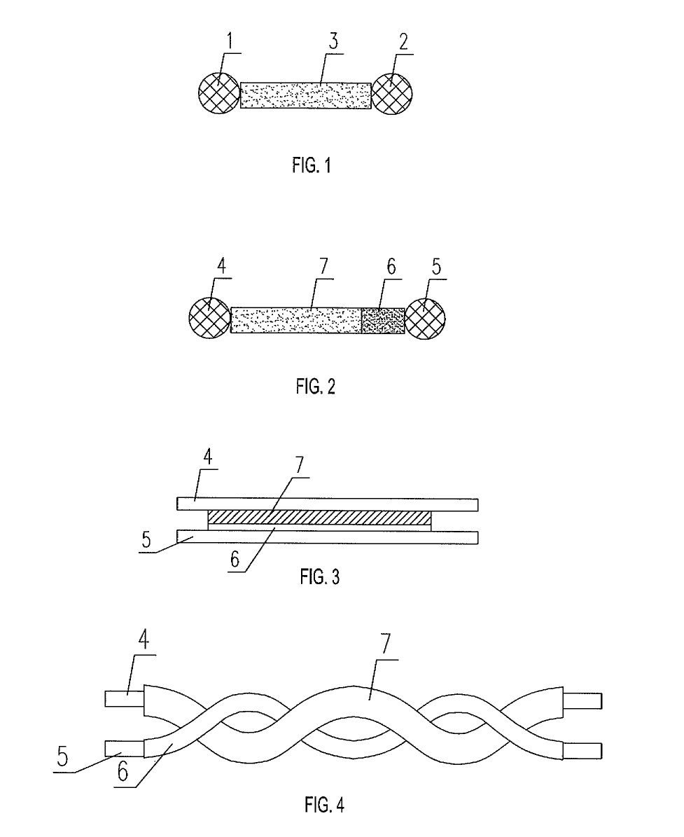

### DESCRIPTION OF THE PREFERRED EMBODIMENTS

Referring to FIG. 2 (FIG. 2 showing only the cross sectional view of the detection cable, while the longitudinal sectional view of the detection cable is omitted), the analog line-type fixed temperature fire alarm detection cable of the present invention comprises two detection conductors provided in parallel, an isolation layer 7 of NTC characteristics, and a fusible insulation layer 6 having a fusion temperature of 20□˜140□. The isolation layer 7 of NTC characteristics and the fusible insulation layer 6 are interposed between the two parallel detection conductors. There are three forms of parallel settings in the present invention.

1. The two detection conductors 4, 5 are provided side by side, as shown in FIG. 3 (FIG. 3 shows only the longitudinal sectional view of the detection cable, while the cross-sectional view of the detection cable is omitted);

2. The two detection conductors 4, 5 are twisted together. That is, one conductor may be twisted on the other or the two are twisted together with an equal pitch, as shown in FIG. 4 (FIG. 4 shows the longitudinal appearance of the detection cable, while the cross-sectional view of the detection cable is omitted); and

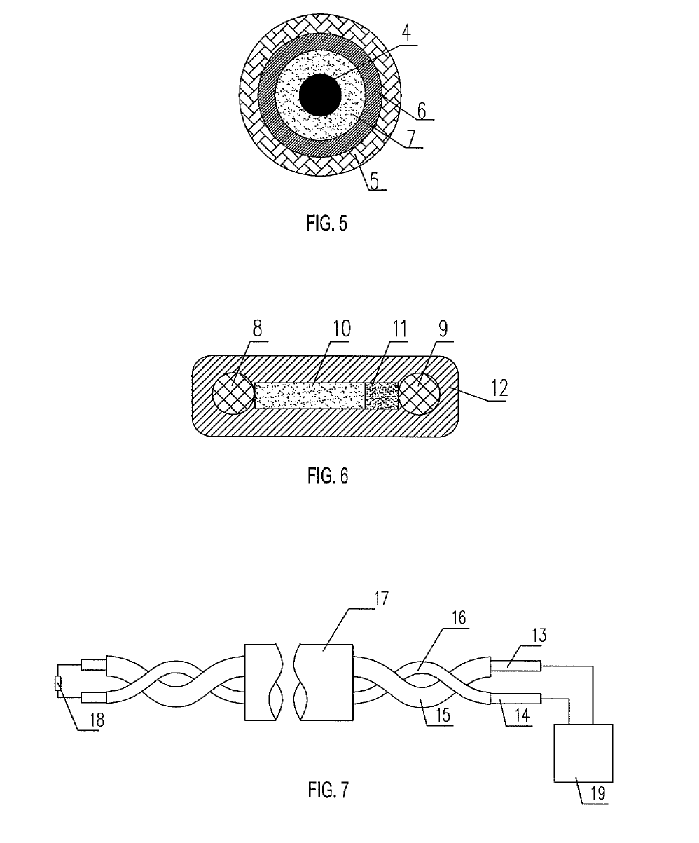

3. One “4” of the two detection conductors 4, 5 is a core-shaped conductor, and the other one “5” is a sleeve-shaped conductor. The sleeve-shaped conductor surrounds the core-shaped conductor to form a coaxial cable structure, as shown in FIG. 5 (FIG. 5 shows the cross-sectional view of the detection cable, while the longitudinal sectional view of the detection cable is omitted).

The detection conductor may be a hollow wire, solid wire or metal fiber woven wire in the present embodiment. In the practical application, the combination of the isolation layer of NTC characteristics and the fusible insulation layer with the detection conductor is in the form of conventional coating of a wire isolation layer, and may be in the following forms:

1. One of the two detection conductors is coated with a fusible insulation layer, while the other one is coated with an isolation layer of NTC characteristics, as shown in FIG. 4.

2. At least one of the two detection conductors is coated with an isolation layer of NTC characteristics and a fusible insulation layer in such an order from inside to outside.

3. At least one of the two detection conductors is coated with a fusible insulation layer and an isolation layer of NTC characteristics in such an order from inside to outside.

In the present embodiment, the fusible insulation layer may be wax, naphthalene, anthracene, stearic acid, or rosone, it may also be polyvinyl chloride, polyethylene, caoutchouc, neoprene or acrylonitrile-butadiene rubber. The fusible insulation layer may have a thickness of 0.05-10 mm. The isolation layer of NTC characteristics (isolation layer of negative temperature coefficient characteristics) is made of one of the high molecular conducting materials including polyacetylene, polyaniline, polythiophene, polyphthalocyanine as main conducting material, and has a thickness of 0.1 mm˜5 mm. The temperature of the detection cable increases when heated. The two detection conductors are insulated from each other when the temperature has not reached the softening (fusing) temperature range of the fusible insulation layer. When the heating temperature of the detection cable continues to increase and reaches the fusing temperature range of the fusible insulation layer, the fusible insulation layer fuses or softens, and deformation stress in the two detection conductors eliminates the insulation resistance of the fusible insulation layer between the two detection conductors where the detection cable is heated. Thus, the detection cable is converted into a conventional NTC analog line-type fixed temperature fire alarm detection cable, the resistance between the two parallel conductors decreases as the temperature increases, and a fixed temperature alarm is performed according to the variance value of other electric parameters resulting from the resistance or resistance variance.

In the present invention, the conductor and insulator as mentioned mean relative conductor and relative insulator, and the difference between a conductor and an insulator may be defined by a ratio of resistance of an insulator to that of a conductor that is greater than 10⁸.

Referring to FIG. 6 (FIG. 6 shows a cross-sectional view of the detection cable, while the longitudinal sectional view of the detection cable is omitted), the second embodiment of the present invention comprises two parallel detection conductors, an isolation layer of NTC characteristics and a fusible insulation layer. The isolation layer of NTC characteristics 10 and the fusible insulation layer 11 are interposed between the two parallel detection conductors 8, and 9.

The detection conductors, isolation layer of NTC characteristics and fusible insulation layer are coated with an insulated sleeve 12. So called parallel means that the two detection conductors are either positioned side by side, or twisted together (one twisting on the other or the two are twisted together in equal pitches manner), or one of the two detection conductors is a core-shape conductor and the other is a sleeve-shape conductor, with the sleeve-shape conductor surrounding the core-shape conductor to form a coaxial cable structure. The insulated sleeve is used to provide insulation from outside.

Referring to FIG. 7, a line-type fixed temperature fire detector with the use of the present invention comprises two parallel detection conductors, an isolation layer of NTC characteristics and a fusible insulation layer. The isolation layer of NTC characteristics and the fusible insulation layer are interposed between the two parallel detection conductors 13 and 14. Detector 13 is coated with an isolation layer 15 of NTC characteristics, Detector 14 is coated with a fusible insulation layer 16, and the detection conductors, isolation layer of NTC characteristics and fusible insulation layer are coated with an insulated sleeve 17. The insulated sleeve is used to provide insulation from outside. The left end of the two detection conductors 13 and 14 is connected in series to a terminating resistor (the resistor having a resistance of 10Ω˜100 MΩ), and the right end of the two detection conductors is connected to a device 19 measuring resistance signal.

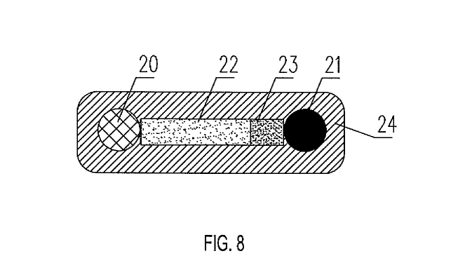

Referring to FIG. 8, (FIG. 8 shows a cross-sectional view of the detection cable, while the longitudinal sectional view of the detection cable is omitted), the third embodiment of the present invention comprises two parallel detection conductors, an isolation layer of NTC characteristics and a fusible insulation layer. The isolation layer of NTC characteristics 22 and the fusible insulation layer 23 are interposed between the two parallel detection conductors 20 and 21. The detection conductors, isolation layer of NTC characteristics and fusible insulation layer are coated with an insulated sleeve 24. At least one (such as 21 in the FIG. 8) of the two detection conductors is a shape memory alloy wire or carbon spring steel wire. Shape memory alloy wire may be nickel-titanium memory alloy, nickel-titanium-copper memory alloy, iron base memory alloy or copper base memory alloy. The design value of the finishing temperature A_{f} of the martensitic reverse transformation of the memory alloy wire may be selected from the range of 20° C.˜140° C. Fusible insulation layer may be wax, naphthaline, anthracene, polyvinyl chloride, polyethylene, caoutchouc, neoprene, or acrylonitrile-butadiene rubber.

1. An analog line-type fixed temperature fire detection cable, wherein said fire detection cable comprises two detection conductors provided in parallel, an isolation layer of NTC characteristics and a fusible insulation layer, the isolation layer of NTC characteristics and the fusible insulation layer being positioned between the two parallel detection conductors, the fusible insulation layer having a fusion temperature in a range of 20° C.˜140° C.

2. The analog line-type fixed temperature fire detection cable according to claim 1, wherein the two detection conductors are arranged side by side.

3. The analog line-type fixed temperature fire detection cable according to claim 1, wherein the two detection conductors are twisted together.

4. The analog line-type fixed temperature fire detection cable according to claim 1, wherein one of the two detection conductors is a sleeve-shape conductor, said sleeve-shape conductor surrounding the other conductor to form a coaxial cable structure.

5. The analog line-type fixed temperature fire detection cable according to claim 1, wherein the detection conductors, isolation layer of NTC characteristics and fusible insulation layer are coated with an insulated sleeve.

6. The analog line-type fixed temperature fire detection cable according to claim 5, wherein the two detection conductors are arranged side by side.

7. The analog line-type fixed temperature fire detection cable according to claim 5, wherein the two detection conductors are twisted together.

8. The analog line-type fixed temperature fire detection cable according to claim 5, wherein one of the two detection conductors is a sleeve-shape conductor, said sleeve-shape conductor surrounding the other conductor to form a coaxial cable structure.

9. The analog line-type fixed temperature fire detection cable according claim 1, wherein at least one of the two detection conductors is a memory alloy wire, material of which is selected from a group consisting of nickel-titanium memory alloy, iron base memory alloy, and copper base memory alloy.

10. The analog line-type fixed temperature fire detection cable according to claim 1, wherein at least one of the two detection conductors is a carbon spring steel wire.

11. The analog line-type fixed temperature fire detection cable according to claim 1, wherein at least one of the two detection conductors is coated with a fusible insulation layer and an isolation layer of NTC characteristics in an order from inside to outside.

12. The analog line-type fixed temperature fire detection cable according to claim 1, wherein at least one of the two detection conductors is coated with an isolation layer of NTC characteristics and a fusible insulation layer in an order from inside to outside.

13. The analog line-type fixed temperature fire detection cable according to claim 1, wherein one of the two detection conductors is coated with a fusible insulation layer, while the other one is coated with an isolation layer of NTC characteristics.

14. The analog line-type fixed temperature fire detection cable according to claim 5, wherein at least one of the two detection conductors is a memory alloy wire, material of which is selected from a group consisting of nickel-titanium memory alloy, iron base memory alloy, and copper base memory alloy.

15. The analog line-type fixed temperature fire detection cable according to claim 5, wherein at least one of the two detection conductors is a carbon spring steel wire.

16. The analog line-type fixed temperature fire detection cable according to claim 5, wherein at least one of the two detection conductors is coated with a fusible insulation layer and an isolation layer of NTC characteristics in an order from inside to outside.

17. The analog line-type fixed temperature fire detection cable according to claim 5, wherein at least one of the two detection conductors is coated with an isolation layer of NTC characteristics and a fusible insulation layer in an order from inside to outside.

18. The analog line-type fixed temperature fire detection cable according to claim 5, wherein one of the two detection conductors is coated with a fusible insulation layer, while the other one is coated with an isolation layer of NTC characteristics.

19. The analog line-type fixed temperature fire detection cable according to claim 2, wherein one of the two detection conductors is coated with a fusible insulation layer, while the other one is coated with an isolation layer of NTC characteristics.

20. The analog line-type fixed temperature fire detection cable according to claim 6, wherein one of the two detection conductors is coated with a fusible insulation layer, while the other one is coated with an isolation layer of NTC characteristics.
